(19) United States
(12) Patent Application Publication
(10) Pub. No.: US 2021/0018935 A1
(43) Pub. Date: Jan. 21, 2021

(54) UNMANNED AERIAL VEHICLE AND METHOD FOR LAUNCHING UNMANNED AERIAL VEHICLE

(71) Applicant: GEOSAT Aerospace & Technology Inc., Tainan City (TW)

(72) Inventors: Yung-Chieh HUANG, Tainan City (TW); Yen-Ping Chen, Tainan City (TW)

(73) Assignee: GEOSAT Aerospace & Technology Inc., Tainan City (TW)

(21) Appl. No.: 16/512,019

(22) Filed: Jul. 15, 2019

(51) Int. Cl. G05D 1/08; G05D 1/06; G05D 1/10; B64C 39/02

(52) U.S. Cl. CPC G05D 1/085; G05D 1/0661; G05D 1/101; B64C 2201/108; B64C 2201/08; B64C 2201/12; B64C 39/024

(57) ABSTRACT

An unmanned aerial vehicle (UAV) includes one or more motors configured to drive one or more propellers of the UAV, a motion sensor configured to determine a motion parameter of the UAV, a memory storing instructions, and a processor coupled to the one or more motors, the motion sensor, and the memory. The processor is configured to execute the instructions to cause the UAV to determine whether a hand thrown mode is selected for the UAV and whether the one or more motors are turned off; responsive to a determination that the hand thrown mode is selected, receive a motion parameter from the motion sensor; and activate the one or more motors when the motion parameter is greater than a threshold value.

### TECHNICAL FIELD

The present disclosure relates to unmanned aerial vehicles (UAVs), and more particularly, to methods and systems for launching unmanned aerial vehicles.

### BACKGROUND

A user generally achieves launching and landing of unmanned aerial vehicles (UAVs) by controlling the UAV with a remote controller or a control system. A traditional launching operation is a manual and non-intuitive process. The user often needs to first find a suitable plane on which to place the UAV, and then control the UAV with the remote controller using both hands. However, ground conditions may not always be suitable for placing the UAV to be launched. For example, there may be soil, mud, rocks, or water that may harm the UAV if placed on the ground. In addition, the ground may be uneven or unsafe to perform a launching. These conditions result in difficulties in the UAV launching process.

Accordingly, there is a need to simplify and improve the launching operation of UAVs, in order to overcome the shortcoming set forth above and to provide a better user experience.

### SUMMARY

The present disclosure provides a non-transitory computer-readable medium storing instructions executable by a processor to perform a method for launching an unmanned aerial vehicle (UAV) including one or more motors and a motion sensor. The method for launching the UAV includes determining whether a hand thrown mode is selected for the UAV and whether the one or more motors are turned off; responsive to a determination that the hand thrown mode is selected, receiving a motion parameter from the motion sensor; and activating one or more of the motors when the motion parameter is greater than a threshold value.

The present disclosure also provides a method for launching a UAV including one or more motors and a motion sensor. The method for launching the UAV includes determining whether a hand thrown mode is selected for the unmanned aerial vehicle and whether the one or more motors are turned off; responsive to a determination that the hand thrown mode is selected, receiving a motion parameter from the motion sensor; and activating one or more of the motors when the motion parameter is greater than a threshold value.

The present disclosure further provides an unmanned aerial vehicle (UAV) including one or more motors configured to drive one or more propellers of the UAV, a motion sensor configured to determine a motion parameter of the UAV, a memory storing instructions; and a processor coupled to the one or more motors, the motion sensor, and the memory. The processor is configured to execute the instructions to cause the UAV to: determine whether a hand thrown mode is selected for the unmanned aerial vehicle and whether the one or more motors are turned off; responsive to a determination that the hand thrown mode is selected, receive a motion parameter from the motion sensor; and activate one or more of the motors when the motion parameter is greater than a threshold value.

It is to be understood that the foregoing general description and the following detailed description are exemplary and explanatory only, and are not restrictive of the disclosure, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1A is a diagram which illustrates an exemplary unmanned aerial vehicle (UAV), consistent with some embodiments of the present disclosure.

FIG. 1B is a diagram which illustrates an exemplary UAV, consistent with some embodiments of the present disclosure.

FIG. 2A to FIG. 2D are diagrams which illustrate different scenarios of launching by throwing a UAV, consistent with some embodiments of the present disclosure.

FIG. 3 is a flow diagram of an exemplary method for launching a UAV, consistent with some embodiments of the present disclosure.

FIG. 4 is a diagram which illustrates signal flow of a UAV, consistent with some embodiments of the present disclosure.

FIG. 5 is a flow diagram of an exemplary method for launching a UAV, consistent with some embodiments of the present disclosure.

FIG. 6A is a graph which illustrates an exemplary curve plotting velocity of a UAV against time during a takeoff stage, consistent with some embodiments of the present disclosure.

FIG. 6B is a graph which illustrates an exemplary curve plotting acceleration of a UAV against time during the takeoff stage, consistent with some embodiments of the present disclosure.

FIG. 7 is a diagram which illustrates movement of a UAV during the takeoff stage, consistent with some embodiments of the present disclosure.

FIG. 8 is a flow diagram of an exemplary method for launching a UAV, consistent with some embodiments of the present disclosure.

### DETAILED DESCRIPTION

The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

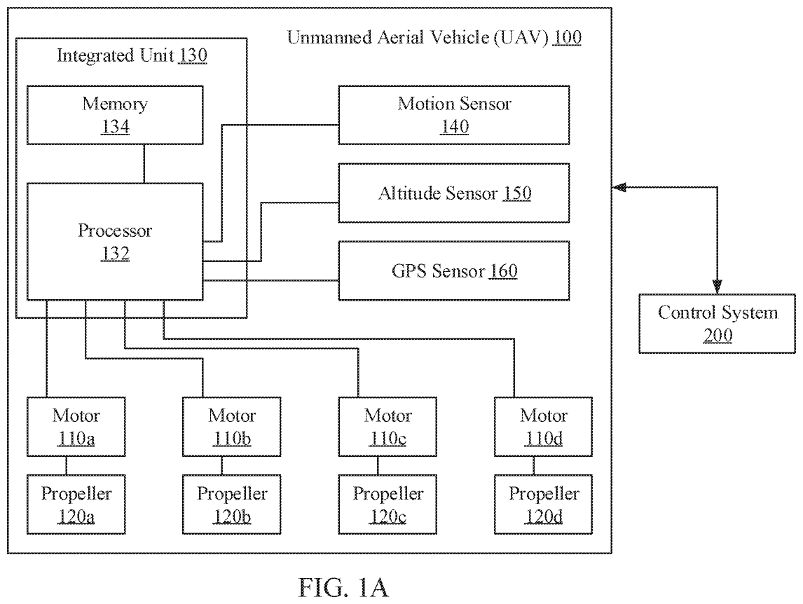

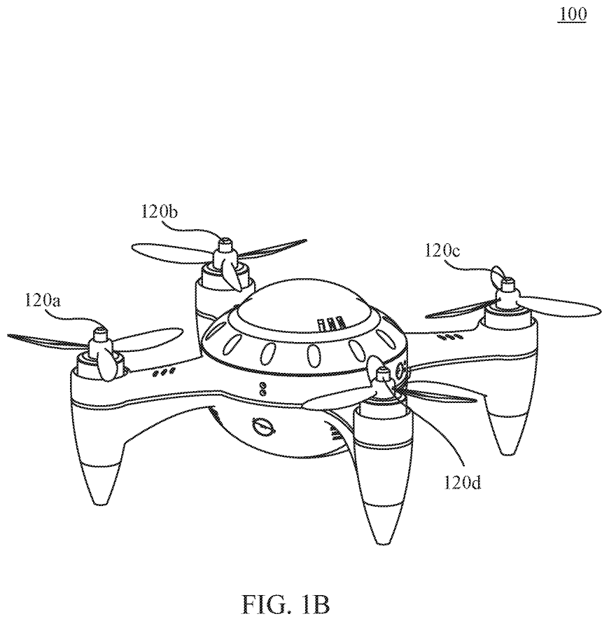

FIG. 1A is a diagram which illustrates an exemplary unmanned aerial vehicle (UAV) 100, consistent with some embodiments of the present disclosure. FIG. 1B is a diagram which illustrates an appearance of UAV 100 illustrated in FIG. 1A, consistent with some embodiments of the present disclosure. As shown in FIG. 1A and FIG. 1B, UAV 100 includes one or more motors 110a-110d, one or more propellers 120a-120d, an integrated unit 130, a motion sensor 140, an altitude sensor 150 and a global positioning system (GPS) sensor 160. In some embodiments, UAV 100 may also include ailerons for generating a rolling motion to enable UAV 100 to pitch, roll, or yaw. Motors 110a-110d are coupled to corresponding propellers 120a-120d, respectively, and are configured to drive propellers 120a-120d to provide propulsion to UAV 100. In various embodiments, the number of motors 110a-110d, and corresponding propellers 120a-120d, may be different, the embodiment illustrated in FIG. 1A and FIG. 1B being merely an example and not intended to limit the present disclosure. For example, UAV 100 may have one, two, three, four, five, six, seven, eight, or any number of motors coupled with corresponding propellers.

Integrated unit 130 is communicatively coupled to motors 110a-110d and configured to control motors 110a-110d to provide lift and propulsion in various flight operations, such as ascending, descending, hovering, or transiting. For example, integrated unit 130 may be configured to transmit driving signals to drive motors 110a-110d, respectively, to control rotational speed of motors 110a-110d. In some embodiments, integrated unit 130 includes a processor 132 and a memory 134 storing instructions for execution by processor 132 to control operation of UAV 100. For example, integrated unit 130 may be configured to control motors 110a-110d to speed up or slow down UAV 100. In some embodiments, integrated unit 130 may increase or decrease a rotational speed of one or more of motors 110a-110d. For example, integrated unit 130 can independently control revolutions per minute (RPM) of each of motors 110a-110d during the flight.

More particularly, memory 134 can store data and/or software instructions executed by processor 132 to perform operations consistent with the disclosed embodiments. For example, processor 132 can be configured to execute a set of instructions stored in memory 134 to cause UAV 100 to perform a method for launching UAV 100 when the user throws UAV 100 into the air, which is discussed in detail below.

Processor 132 can be, for example, one or more central processors or microprocessors. Memory 134 can be any of various computer-readable media implemented in any method or technology for storage of information such as computer-readable instructions, data structures, program modules, or other data. Memory 134 can be communicatively coupled with processor 132 via a bus. In some embodiments, memory 134 may include a main memory, such as, for example, a random access memory (RAM) or other dynamic storage device, which can be used for storing temporary variables or other intermediate information during execution of instructions by processor 132. Such instructions enable UAV 100 to perform operations specified in the instructions.

In some embodiments, before loaded into memory 134, the instructions may be stored in any of non-transitory storage media accessible to integrated unit 130. The term “non-transitory media” as used herein refers to any non-transitory media storing data or instructions that cause a machine to operate in a specific fashion. Such non-transitory media can include non-volatile media and/or volatile media. Non-transitory media include, for example, optical or magnetic disks, dynamic memory, a floppy disk, a flexible disk, hard disk, solid state drive, magnetic cassettes, magnetic tape, or any other magnetic data storage medium, a CD-ROM, digital versatile disks (DVD) or any other optical data storage medium, a Random Access Memory (RAM), a read-only memory (ROM), a Programmable Read-Only Memory (PROM), a EPROM, a FLASH-EPROM, NVRAM, flash memory, or other memory technology and/or any other storage medium with the same functionality that can be contemplated by persons of ordinary skill in the art to which this disclosure pertains. Other components known to one of ordinary skill in the art may be included in UAV 100 to process, transmit, provide, and receive information consistent with the disclosed embodiments.

Motion sensor 140 is communicatively coupled to integrated unit 130 and configured to determine a motion parameter of UAV 100 and transmit the determined motion parameter to integrated unit 130 for further data processing and control of UAV 100. For example, the motion parameter determined by motion sensor 140 may include velocity, acceleration, or other parameters to describe movements of UAV 100. More particularly, motion sensor 140 may include one or more sensing components such as a solid-state or microelectromechanical systems (MEMS) accelerometer, a gravity sensor, a gyroscope, a magnetometer, and/or a rotation vector sensor, to sense velocity and/or acceleration of UAV 100, but the present disclosure is not limited thereto.

In some embodiments, the one or more sensing components in motion sensor 140 may function independently or be integrated in a single module to perform the sensing. For example, the sensing components described above may be deployed on three axes, so that motion sensor 140 may provide attitude information of UAV 100, such as a roll angle, a pitch angle, and/or a yaw angle. In some embodiments, the sensing components may also be referred to as magnetic, angular rate, and gravity (MARG) sensors. Accordingly, motion sensor 140 may function in conjunction with integrated unit 130 to achieve an attitude and heading reference system (AHRS), to provide attitude determination of UAV 100. The AHRS of UAV 100 may also form a subsystem or part of an inertial navigation system, including integrated unit 130, motion sensor 140, altitude sensor 150, and GPS sensor 160, of UAV 100.

Altitude sensor 150 is communicatively coupled to integrated unit 130 and configured to determine a current altitude of UAV 100 and transmit the determined current altitude to integrated unit 130 for further data processing and control of UAV 100. For example, altitude sensor 150 may be implemented by an altimeter, a barometric pressure sensor (e.g., a barometer), or any other altitude-sensing device.

GPS sensor 160 is communicatively coupled to integrated unit 130 and configured to record a takeoff position of UAV 100 and determine a current position of UAV 100. More particularly, GPS sensor 160 includes an onboard receiver configured to receive data signals transmitted from one or more satellites in a global positioning satellite constellation. Accordingly, with respect to a global framework, GPS sensor 160 is capable of determining and monitoring an absolute position of UAV 100 based on the received data signals continuously, periodically, or intermittently. During a takeoff period of UAV 100, GPS sensor 160 may determine and record the takeoff position, which indicates the position of UAV 100 at the takeoff. Similarly, during a landing period of UAV 100, GPS sensor 160 may also determine and record the landing position, which indicates the position of UAV 100 at the landing.

In addition, during the flight of UAV 100, GPS sensor 160 may also determine and record the current position of UAV 100 with a timestamp, periodically or intermittently. The recording of the current position of UAV 100 may be performed automatically, based on one or more preset rules, or manually. That is, UAV 100 can trigger the GPS recording when one or more conditions are met, such as conditions related to a flight time, a flight distance, a flight altitude, a pitch or a roll angle, a battery status, etc.

Furthermore, in some embodiments, UAV 100 can transmit data to and communicate with other electronic devices through a communication circuit and one or more antenna units (not shown). For example, UAV 100 can receive a communication signal from an external control system 200, by means of the communication circuit and antenna units. Accordingly, a user can monitor and/or control UAV 100 to perform flight operations and set one or more operating parameters of UAV 100 by means of control system 200. For example, control system 200 may include a ground control station (GCS) or a remote controller. In some embodiments, the GCS can be run on a desktop computer, a laptop, a tablet, a smartphone, or any other electronic device. The user can input one or more instructions to control system 200. After receiving the instruction, control system 200 may transmit a signal associated with the instruction to communicate with UAV 100 through the communication circuit. In addition, UAV 100 can also communicate with a display device, a server, a computer system, a datacenter, or other UAVs by means of the communication circuit and the antenna units via radio frequency (RF) signals or any type of wireless network.

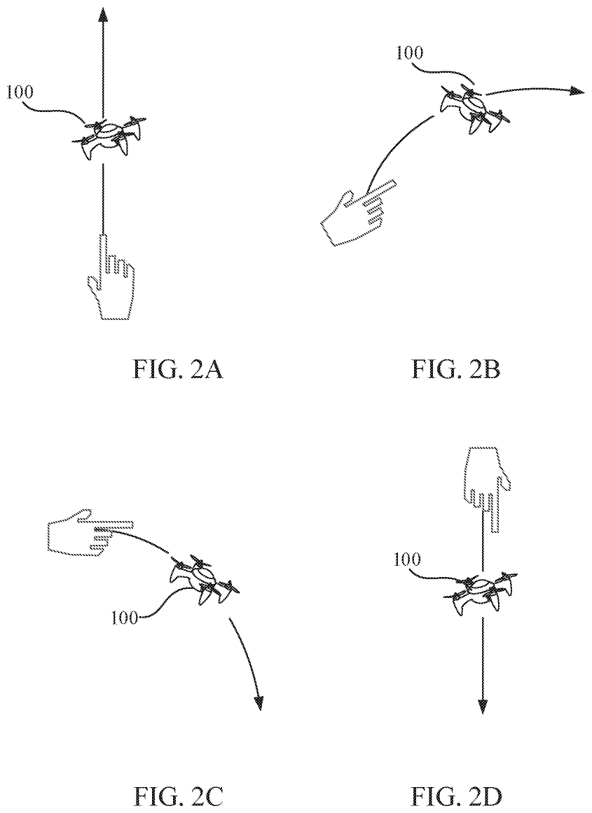

A hand thrown mode can be selected for UAV 100. When UAV 100 operates in the hand thrown mode, the user can provide a launching command and trigger UAV 100 to execute launching by throwing UAV 100 in any direction. By providing the hand thrown mode to launch UAV 100, an improved human-machine interaction can be accomplished with simple and intuitive operations. FIG. 2A to FIG. 2D are diagrams which illustrate different scenarios of launching by throwing UAV 100, consistent with some embodiments of the present disclosure. As shown in FIG. 2A, the user can throw UAV 100 into the air in an upward direction against gravity. As shown in FIG. 2B, the user can also throw UAV 100 with an initial velocity and a positive initial launch angle with respect to the horizontal. As shown in FIG. 2C, the user can further throw UAV 100 with an initial velocity and a zero or a negative initial launch angle with respect to the horizontal. As shown in FIG. 2D, the user can even drop UAV 100 without providing an initial velocity. Assuming the effects of air resistance are negligible, UAV 100 is in a free fall state after the throw and gravity acts downwardly on UAV 100, which imparts a downward acceleration to UAV 100. Accordingly, UAV 100 may detect its status and determine that a throw to launch is performed based on the motion parameter(s) determined by motion sensor 140. In response to a determination that the throw is performed and the hand thrown mode is selected, integrated unit 130 can transmit corresponding instructions to activate motors 110a-110d. Thus, the activated motors 110a-110d can drive propellers 120a-120d, respectively, to successfully launch UAV 100.

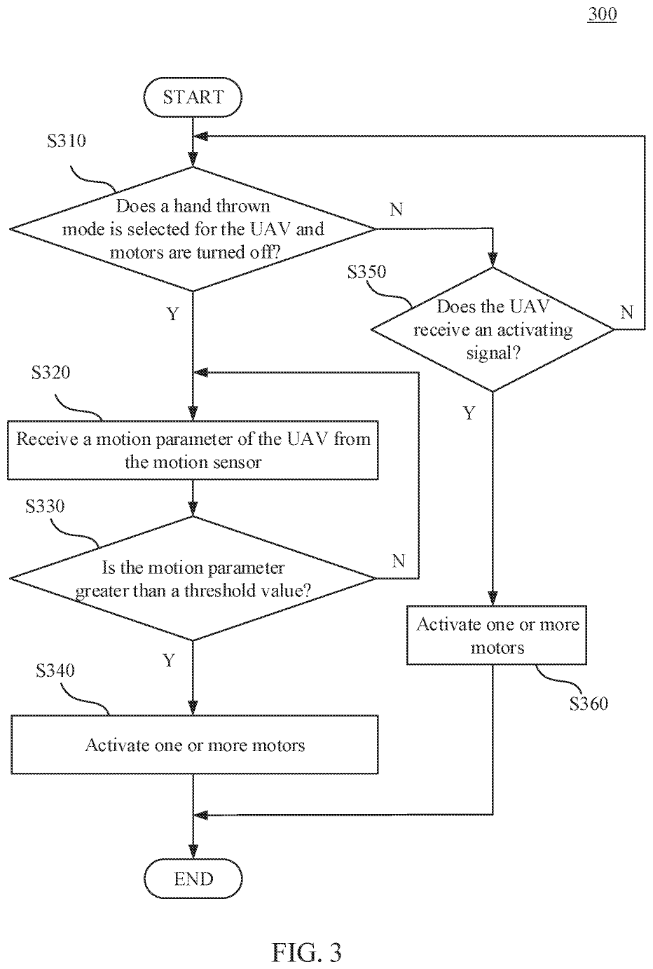

FIG. 3 is a flow diagram of an exemplary method 300 for launching UAV 100, consistent with some embodiments of the present disclosure. Method 300 can be performed by a UAV (e.g., UAV 100 in FIGS. 1A and 1B) including one or more motors, e.g., 110a-110d, and motion sensor, e.g., 140, but the present disclosure is not limited thereto. In some embodiments, processor 132 can be configured to execute instructions stored in memory 134 to cause UAV 100 to perform steps of method 300 for launching UAV 100.

In step S310, UAV 100 determines whether a hand thrown mode for launching is selected for UAV 100 and whether motors 110a-110d are turned off. The hand thrown mode may be selected by the user in various manners. For example, the user may trigger a physical switching device, such as a switch or a button on UAV 100, to select the hand thrown mode. The user may also interact with UAV 100 and select the hand thrown mode via any other input interface, such as a touch screen, a voice control system, a gesture-based control system which is able to recognize a user's hand gesture, etc. The user can also send a corresponding wireless signal from control system 200 as a command for selecting the hand thrown mode. When processor 132 receives a signal of selecting the hand thrown mode from the physical switching element or one of the input interfaces located on UAV 100, or from control system 200 communicating with UAV 100 via wireless communication, processor 132 selects and triggers the hand thrown mode. Other approaches may also be applied for selecting the hand thrown mode, and thus implementations discussed above are merely examples and not intended to limit the present disclosure. UAV 100 may also determine whether motors 110a-110d are turned off, which indicates that UAV 100 awaits takeoff.

Responsive to a determination that UAV 100 operates in the hand thrown mode (step S310—yes), UAV 100 performs step S320. In step S320, UAV 100 receives a motion parameter from motion sensor 140. As discussed above, the motion parameter may include an upward acceleration against gravity of UAV 100, and/or a velocity of UAV 100. The velocity may be defined as a total velocity, or a velocity component along a predetermined direction, such as the velocity in a downward direction due to gravity (i.e., a vertical component of the total velocity of UAV 100).

In step S330, UAV 100 determines whether the received motion parameter is greater than a threshold value. In various embodiments, different threshold values may be set according to different types of motion parameters. For example, the threshold value may include an acceleration threshold for the motion parameter being upward acceleration, and/or a velocity threshold for the motion parameter being velocity.

Responsive to a determination that the received motion parameter is smaller than the threshold value (step S330—no), UAV 100 may repeat steps S320 and S330 to update the motion parameter of UAV 100 periodically or intermittently, until the motion parameter reaches the threshold value. Thus, before the user actually throw UAV 100 into the air, UAV 100 functions in a standby mode and keeps detecting whether a throw occurs. On the other hand, responsive to a determination that the received motion parameter is greater than the threshold value (step S330—yes), UAV 100 determines that the throw occurs and performs step S340. In step S340, UAV 100 activates motors 110a-110d. By performing steps S320-S340, UAV 100 activates motors 110a-110d when the received motion parameter is greater than the threshold value. Thus, UAV 100 achieves hand launching.

On the other hand, responsive to a determination that UAV 100 does not operate in the hand thrown mode (step S310—no), UAV 100 may perform step S350 and determine whether UAV 100 receives an activating signal for activating motors 110a-110d in a manual mode from control system 200. Responsive to a determination that the activating signal is received (step S350—yes), UAV 100 performs step S360 and activates motors 110a-110d. Responsive to a determination that the activating signal is not received (step S350—no), UAV 100 may repeat steps S310 and S350, until UAV 100 operates in the hand thrown mode (step S310—yes) or until UAV 100 receives the activating signal in the manual mode (step S350—yes).

In some embodiments, after the determination that the received motion parameter is greater than the threshold value (step S330—yes), UAV 100 can further set a delay (e.g., 0.8 seconds), and/or make multiple confirmations of the received motion parameter before performing step S340. Accordingly, UAV 100 can avoid misoperation or accidental activation of UAV 100. For example, UAV 100 may check the received motion parameter again after delaying for a period (e.g., 0.8 seconds), and then determine whether to perform step S340 and activate motors 110a-110d accordingly.

By implementing hand launching described above, even if the user cannot find a proper surface on which to place UAV 100, the launching of UAV 100 can be achieved with a single throw, and is not limited by the condition of the ground, such as soil, mud, rocks, or water on the ground. Furthermore, the foregoing launching operation may be accomplished by using one hand, which is more convenient and brings more flexibility to the user in different application scenario.

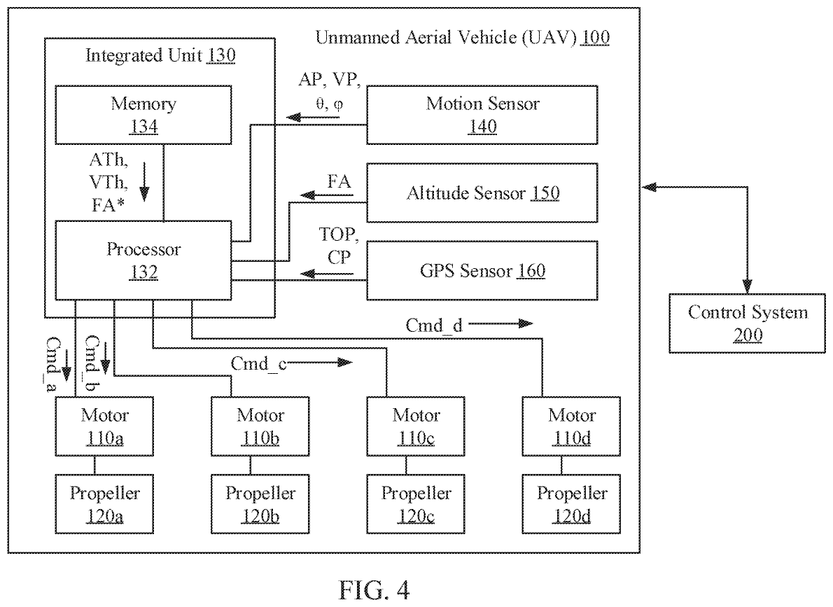

FIG. 4 is a diagram which illustrates signal flow of UAV 100 during operations of method 300 shown in FIG. 3, consistent with some embodiments of the present disclosure. As shown in FIG. 4, in some embodiments, threshold values, such as an acceleration threshold ATh and/or a velocity threshold VTh may be preset and stored in memory 134. More particularly, memory 134 may further store a predetermined flight altitude FA*, which indicates a default target flight altitude for UAV 100 to hover at after the takeoff operation is completed. In some embodiments, the user can also adjust the value of acceleration threshold ATh, velocity threshold VTh, and/or predetermined flight altitude FA* stored in memory 134 via control system 200. Accordingly, processor 132 can obtain the stored acceleration threshold ATh, velocity threshold VTh, and/or predetermined flight altitude FA* to perform method 300.

Motion sensor 140 may transmit an acceleration parameter AP and/or a velocity parameter VP as the motion parameter to processor 132. In addition, motion sensor 140 may further transmit one or more attitude parameters, such as a roll angle φ and a pitch angle θ of a current attitude of UAV 100 to processor 132. Accordingly, processor 132 can perform processing and control motors 110a-110d accordingly in order to stabilize a current attitude of UAV 100.

Altitude sensor 150 may transmit a current altitude FA to processor 132. Accordingly, processor 132 can perform processing and control motors 110a-110d. For example, processor 132 may provide corresponding commands Cmd_a-Cmd_d to motors 110a-110d respectively to increase or decrease RPM values of motors 110a-110d according to current altitude FA and/or attitude parameters including roll angle φ and pitch angle θ. As a result, UAV 100 may ascend or descend to adjust current altitude FA until predetermined flight altitude FA* is reached, with a stabilized attitude during the ascending or descending.

GPS sensor 160 may record and transmit, to processor 132, a takeoff position TOP during the takeoff, and a current position CP after the takeoff. Processor 132 may provide corresponding commands Cmd_a-Cmd_d to motors 110a-110d respectively to move UAV 100 to a target position, such as takeoff position TOP. For example, before receiving further instructions from the user, UAV 100 may hover at takeoff position TOP. Sometimes, the position of UAV 100 after the takeoff may be distance from the user due to a windy weather condition or due to the stabilization process during an initial takeoff period. If the distance between takeoff position TOP and current position CP is greater than a tolerance value, processor 132 may provide corresponding commands Cmd_a-Cmd_d to motors 110a-110d, respectively, to adjust the position of UAV 100, so that UAV 100 hovers, with predetermined flight altitude FA*, at takeoff position TOP and awaits further instructions.

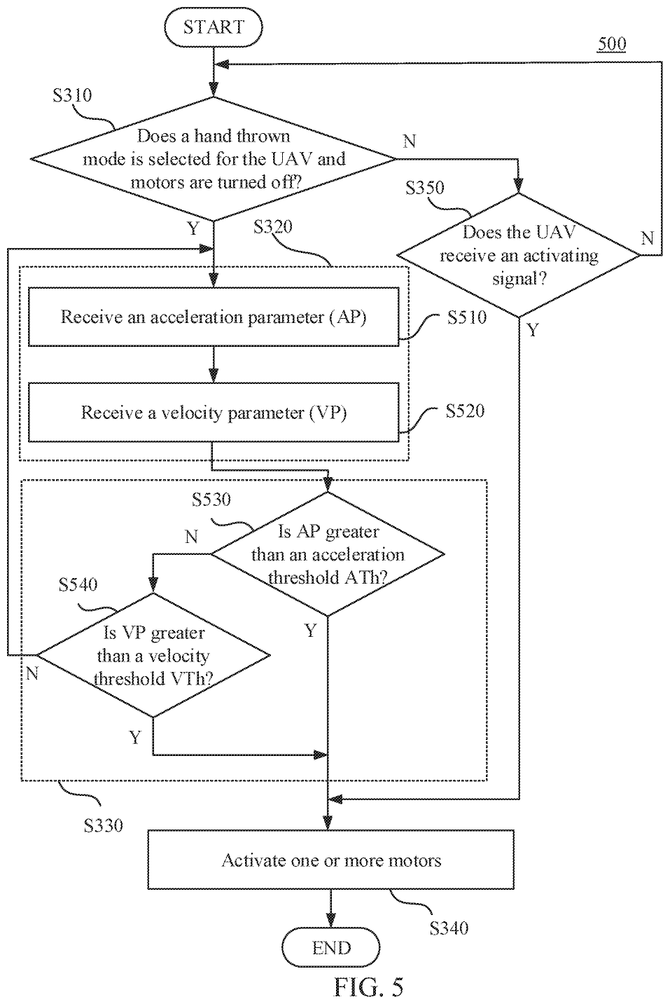

For further understanding of step S320 and step S330, reference is made to FIG. 5, which is a flow diagram of an exemplary method 500 for launching UAV 100, consistent with some embodiments of the present disclosure. Method 500 can be performed by a UAV (e.g., UAV 100 in FIGS. 1A, 1B and FIG. 4). Similar to method 300 in FIG. 3, in some embodiments, processor 132 can be configured to execute instructions stored in memory 134 to cause UAV 100 to perform steps of method 500 for launching UAV 100. Compared to method 300 in FIG. 3, in method 500, step S320 further includes steps S510 and S520.

In step S510, processor 132 receives a signal indicating an upward acceleration (e.g., acceleration parameter AP in FIG. 4), determined by motion sensor 140, against gravity of UAV 100. In step S520, processor 132 receives a signal indicating a velocity (e.g., velocity parameter VP in FIG. 4), determined by motion sensor 140. In some embodiments, the velocity may refer to the total velocity, or the velocity corresponding to a vertical component of velocity in a downward direction due to gravity. That is, motion sensor 140 may determine the total velocity of UAV 100, and/or the vertical component of velocity of UAV 100 as velocity parameter VP.

In view of above, UAV 100 may receive the motion parameter in step S320 by performing step S510 and step S520, but the present disclosure is not limited thereto. In some embodiments, instead of receiving both acceleration parameter AP and velocity parameter VP, UAV 100 may also receive only one of acceleration parameter AP or velocity parameter VP as the motion parameter for later operation in step S330.

Compared to method 300 in FIG. 3, in method 500, step S330 further includes steps S530 and S540. As discussed above, threshold values applied in step S330 (e.g., velocity threshold VTh and acceleration threshold ATh in FIG. 4) may be set according to different types of motion parameters. In the embodiments shown in FIG. 3, the threshold value includes acceleration threshold ATh and velocity threshold Vth.

In step S530, UAV 100 determines whether the received acceleration parameter AP is greater than acceleration threshold ATh (e.g., 2.5 m/s²). Responsive to a determination that the received acceleration parameter AP is greater than acceleration threshold ATh (step S530—yes), UAV 100 determines that the throw occurs and performs step S340 to activate motors 110a-110d. That is, UAV 100 activates motors 110a-110d when the upward acceleration is greater than acceleration threshold ATh.

More particularly, in the scenarios described in FIG. 2A or FIG. 2B, when the user throws UAV 100 along an upward direction against gravity, or along a direction with a positive initial launch angle with respect to the horizontal, the force acting on UAV 100 produces an acceleration before leaving the hand of the user. Accordingly, motion sensor 140 may determine a vertical component of the acceleration along the upward direction against gravity, that is, acceleration parameter AP. During the act of throwing, the determined acceleration parameter AP increases and reaches acceleration threshold ATh. Accordingly, in response to an identification that acceleration parameter AP exceeds acceleration threshold ATh, processor 132 may determine that the throw occurs.

On the other hand, responsive to a determination that acceleration parameter AP is smaller than acceleration threshold ATh (step S530—no), UAV 100 performs step S540. In step S540, UAV 100 further determines whether the received velocity parameter VP is greater than velocity threshold VTh (e.g., 2.5 m/s). Responsive to a determination that the received velocity parameter VP is greater than velocity threshold VTh (step S540—yes), UAV 100 determines that the throw occurs and performs step S340 to activate motors 110a-110d. That is, UAV 100 activates motors 110a-110d when the velocity is greater than velocity threshold VTh.

More particularly, in some embodiments, velocity threshold VTh may be defined as a threshold value of the total velocity, a threshold value of velocity along an upward direction against gravity, and/or a threshold value of velocity along a downward direction due to gravity based on practical needs. For example, in the scenarios described in FIG. 2A or FIG. 2B, the user holds UAV 100 and provides a force, partially or fully along the upward direction, on UAV 100. The acceleration in the upward direction results in the total velocity or the velocity along the upward direction exceeding a threshold value at the time UAV 100 leaves the user's hand.

Even if the total velocity or the upward velocity does not exceed the threshold value at the time UAV 100 leaves the user's hand, in the scenarios described in FIG. 2A to FIG. 2D, UAV 100 enters the free fall state after leaving the hand of the user, and gravity imparts a downward acceleration to UAV 100. After a period of time, the increasing vertical component of velocity as well as the increasing total velocity of UAV 100 falling will reach velocity threshold VTh before UAV 100 hits the ground. Accordingly, in response to an identification that velocity parameter VP exceeds velocity threshold VTh, processor 132 may also determine that the throw occurs.

On the other hand, responsive to a determination that the received velocity parameter VP is smaller than velocity threshold VTh (step S540—no), UAV 100 repeats steps S510-S540 to update acceleration parameter AP and velocity parameter VP periodically or intermittently, until UAV 100 determines that the throw occurs.

The embodiments discussed above are merely examples and not intended to limit the present disclosure. In various embodiments, other approaches may be applied for steps S320 and S330. For example, steps S520 and S540 associated with velocity parameter VP may be eliminated or bypassed. Accordingly, UAV 100 performs steps S320 and S330 only with acceleration parameter AP as the motion parameter. Similarly, steps S510 and S530 associated with acceleration parameter AP may be eliminated or bypassed. Accordingly, UAV 100 performs steps S320 and S330 only with velocity parameter VP as the motion parameter.

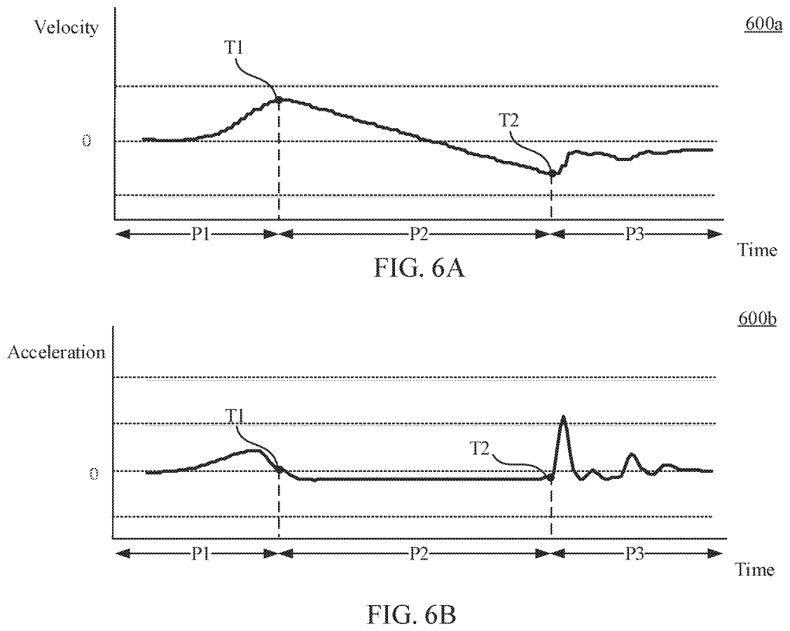

FIG. 6A is a graph which illustrates an exemplary curve 600a plotting velocity of UAV 100 against time during the takeoff stage, consistent with some embodiments of the present disclosure. FIG. 6B is a graph which illustrates an exemplary curve 600b plotting acceleration of UAV 100 against time during the takeoff stage, corresponding to curve 600a in FIG. 6A and consistent with some embodiments of the present disclosure. In FIG. 6A and FIG. 6B, a positive value indicates the direction of velocity or acceleration in the upward direction against gravity, and a negative value indicates the direction of velocity or acceleration in the downward direction due to gravity.

As depicted in FIG. 6A and FIG. 6B, in period P1, as the user holds UAV 100 and provides a launching by throwing, partially or fully along the upward direction, on UAV 100, the acceleration is in the upward direction and the velocity of UAV 100 increases toward the upward direction. Then, at time point T1, UAV 100 leaves the hand of the user. Accordingly, in period P2, gravity contributes a constant acceleration, i.e., gravitational acceleration g, which is approximately 9.8 m/s² in the downward direction. As the velocity of UAV 100 decreases, UAV 100 reaches at its highest altitude point in the free fall state when the velocity is zero.

Then, at time point T2, in response to the determination that the throw occurs and the activation of motors 110a-110d, propellers 120a-120d start to rotate, providing propulsion to UAV 100. Accordingly, a peak occurs in curve 600b with a positive value, indicating acceleration in the upward direction resulting from rotating propellers 120a-120d. In period P3, UAV 100 performs a stabilization process in order to stabilize the attitude, such as the pitch angle, the roll angle, and yaw angle of UAV 100 and adjusts the altitude of UAV 100. In some embodiments, acceleration and velocity of UAV 100 in period P3 vary due to dynamic adjustments to the RPM values of motors 110a-110d and changing weather condition.

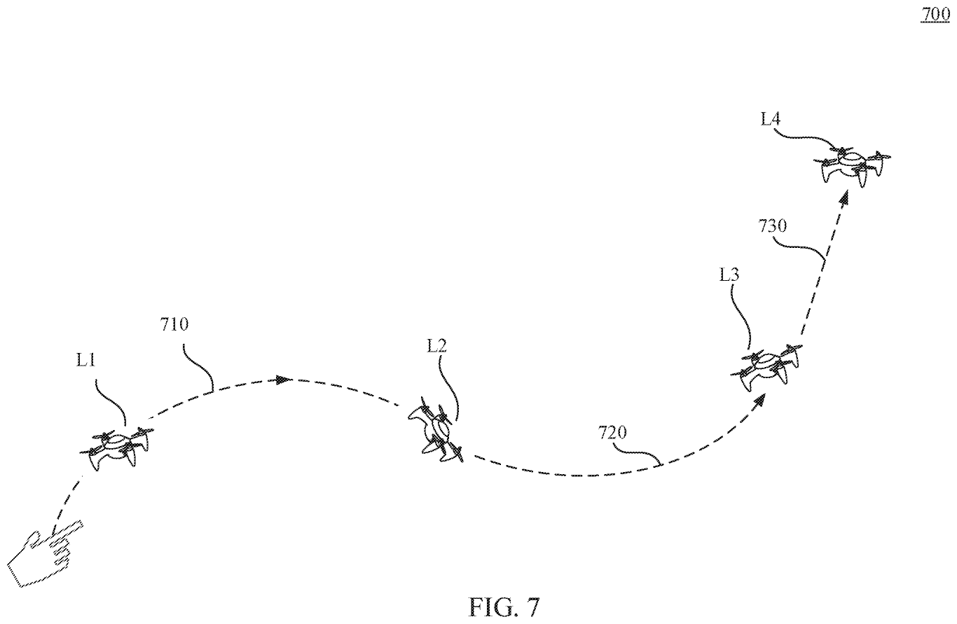

FIG. 7 is a diagram which illustrates an exemplary movement of UAV 100 during the takeoff stage, corresponding to curve 600a in FIG. 6A and curve 600b in FIG. 6B and consistent with some embodiments of the present disclosure. As shown in FIG. 7, location L1 indicates a position of UAV 100 at time point T1 when UAV 100 leaves the hand of the user. Curve 710 shows a trajectory of UAV 100 when motors 110a-110d are inactivated during period P2. UAV 100 first reaches the highest altitude point in the free fall state with zero velocity, and then starts to fall.

Location L2 indicates a position of UAV 100 at time point T2 when propellers 120a-120d start to rotate. Curve 720 shows a trajectory of UAV 100 when motors 110a-110d are activated during period P2. With the acceleration against the gravity, UAV 100 starts to ascend and, during ascending, attains a stable attitude. Location L3 indicates a position of UAV 100 when the takeoff process is completed. Curve 730 shows a trajectory of UAV 100 when UAV 100 is controlled and moves to a desired position (e.g., the recorded takeoff position), hovering at the predetermined flight altitude. Finally, UAV 100 hovers at location L4, awaiting further user instruction.

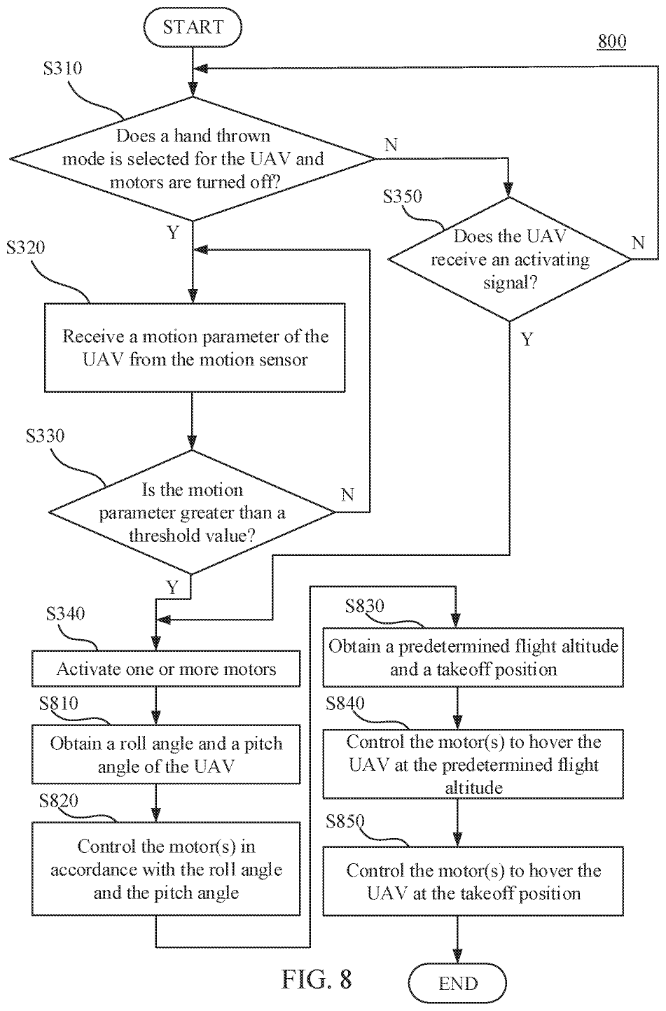

FIG. 8 is a flow diagram of an exemplary method 800 for launching UAV 100, consistent with some embodiments of the present disclosure. Similar to method 300 and method 500 discussed above, method 800 can also be performed by a UAV (e.g., UAV 100 in FIGS. 1A, 1B and FIG. 4), in which processor 132 is configured to execute instructions stored in memory 134 to cause UAV 100 to perform steps in method 800. Compared to method 300 in FIG. 3, method 800 further includes steps S810, S820, S830, S840, and S850, which are performed when the motion parameter is greater than the threshold value (step S330—yes).

In step S810, processor 132 obtains attitude parameters including roll angle φ and pitch angle θ of UAV 100 determined by motion sensor 140. In step S820, processor 132 controls, after activating motors 110a-110d in step S340, motors 110a-110d in accordance with roll angle φ and pitch angle θ to stabilize an attitude of UAV 100. More particularly, processor 132 may respectively provide corresponding commands Cmd_a-Cmd_d to motors 110a-110d so as to increase or decrease RPM values of some or all of motors 110a-110d. By operations performed in steps S810 and S820, UAV 100 may adjust and stabilize its current attitude to prevent stalling of UAV 100.

In step S830, processor 132 obtains predetermined flight altitude FA* of UAV 100 stored in memory 134 and takeoff position TOP of UAV 100 recorded by GPS sensor 160.

In step S840, processor 132 controls, after activating motors 110a-110d in step S340, motors 110a-110d to adjust current altitude FA to predetermined flight altitude FA*, to hover UAV 100. In step S850, processor 132 controls, after activating motors 110a-110d in step S340, motors 110a-110d to move UAV 100 to takeoff position TOP in accordance with current position CP. More particularly, altitude sensor 150 may record and transmit current altitude FA of UAV 100 to processor 132 periodically or intermittently. Similarly, GPS sensor 160 may also record and transmit current position CP of UAV 100 to processor 132 periodically or intermittently. Accordingly, processor 132 may perform various feedback control processes to cause UAV 100 to fly to the desired position and desired altitude. Similar to operations in step S820, in steps S840 and S850, processor 132 may respectively provide corresponding commands Cmd_a-Cmd_d to increase or decrease RPM values of some or all of motors 110a-110d. Thus, UAV 100 may adjust its position and hover at the desired altitude.

In some embodiments, all motors 110a-110d are activated and turned on to rotate propellers 120a-120d. In some embodiments, one or some of motors 110a-110d may remain off, if propulsion provided to UAV 100 is still sufficient to launch UAV 100, stabilize the attitude of UAV 100, and maintain the hover altitude.

In view of above, in various embodiments of the present disclosure, UAV 100 can detect a motion parameter indicating velocity or acceleration of UAV 100 to determine whether a throw occurs when UAV 100 operates in a hand thrown launch mode, and achieve hand launching by operations described above. Thus, even if the user cannot find a proper surface on which to place UAV 100, the launching of UAV 100 can be achieved with a single throw, and is not limited by the condition of the ground. Furthermore, the foregoing launching operations may be accomplished by using one hand, which is more convenient and brings greater flexibility to the user in different application scenarios. Accordingly, the hand launching can provide an improved user experience with simple and intuitive operations.

The various example embodiments herein are described in the general context of method steps or processes, which may be implemented in one aspect by a computer program product, embodied in a transitory or a non-transitory computer-readable medium, including computer-executable instructions, such as program code, executed by computers in networked environments. A computer-readable medium may include removable and nonremovable storage devices including, but not limited to, Read Only Memory (ROM), Random Access Memory (RAM), compact discs (CDs), digital versatile discs (DVD), etc.

Generally, program modules may include routines, programs, objects, components, data structures, etc., that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

In the foregoing specification, embodiments have been described with reference to numerous specific details that can vary from implementation to implementation. Certain adaptations and modifications of the described embodiments can be made. It is also intended that the sequence of steps shown in figures are only for illustrative purposes and are not intended to be limited to any particular sequence of steps. As such, those skilled in the art can appreciate that these steps can be performed in a different order while implementing the same method.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

In the drawings and specification, there have been disclosed exemplary embodiments. It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

What is claimed is:

1. A non-transitory computer-readable medium storing instructions executable by a processor to perform a method for launching an unmanned aerial vehicle including one or more motors and a motion sensor, the method comprising:
determining whether a hand thrown mode is selected for the unmanned aerial vehicle and whether the one or more motors are turned off;
responsive to a determination that the hand thrown mode is selected, receiving a motion parameter from the motion sensor; and
activating one or more of the motors when the motion parameter is greater than a threshold value.

2. The non-transitory computer-readable medium of claim 1, wherein the motion parameter comprises an upward acceleration against gravity, determined by the motion sensor, of the unmanned aerial vehicle, and the threshold value comprises an acceleration threshold, the activating comprising:
activating one or more of the motors when the upward acceleration is greater than the acceleration threshold.

3. The non-transitory computer-readable medium of claim 1, wherein the motion parameter comprises a velocity, determined by the motion sensor, and the threshold value comprises a velocity threshold, the activating comprising:
activating one or more of the motors when the velocity is greater than the velocity threshold.

4. The non-transitory computer-readable medium of claim 3, wherein the velocity corresponds to a vertical component of velocity, determined by the motion sensor, in a downward direction due to gravity.

5. The non-transitory computer-readable medium of claim 1, the method further comprising:
obtaining a roll angle and a pitch angle, determined by the motion sensor, of the unmanned aerial vehicle; and
controlling, after the activating, one or more of the motors in accordance with the roll angle and the pitch angle to stabilize an attitude of the unmanned aerial vehicle.

6. The non-transitory computer-readable medium of claim 1, wherein the unmanned aerial vehicle further includes an altitude sensor for determining a current altitude of the unmanned aerial vehicle, the method further comprising:
determining a predetermined flight altitude of the unmanned aerial vehicle; and
controlling, after the activating, one or more of the motors to adjust the current altitude to the predetermined flight altitude, to hover the unmanned aerial vehicle.

7. The non-transitory computer-readable medium of claim 1, wherein the unmanned aerial vehicle further includes a global positioning system (GPS) sensor for determining a current position of the unmanned aerial vehicle, the method further comprising:
determining, when the motion parameter is greater than the threshold value, a takeoff position recorded by the global positioning system (GPS) sensor; and
controlling, after the activating, one or more of the motors to move the unmanned aerial vehicle to the takeoff position in accordance with the current position.

8. A method for launching an unmanned aerial vehicle including one or more motors and a motion sensor, comprising:
determining whether a hand thrown mode is selected for the unmanned aerial vehicle and whether the one or more motors are turned off;
responsive to a determination that the hand thrown mode is selected, receiving a motion parameter from the motion sensor; and
activating one or more of the motors when the motion parameter is greater than a threshold value.

9. The method of claim 8, wherein the motion parameter comprises an upward acceleration against gravity, determined by the motion sensor, of the unmanned aerial vehicle, and the threshold value comprises an acceleration threshold, the activating further comprising:
activating one or more of the motors when the upward acceleration is greater than the acceleration threshold.

10. The method of claim 8, wherein the motion parameter comprises a velocity, determined by the motion sensor, and the threshold value comprises a velocity threshold, the activating further comprising:
activating one or more of the motors when the velocity is greater than the velocity threshold.

11. The method of claim 10, wherein the velocity corresponds to a vertical component of velocity, determined by the motion sensor, in a downward direction due to gravity.

12. The method of claim 8, further comprising:
obtaining a roll angle and a pitch angle, determined by the motion sensor, of the unmanned aerial vehicle; and
controlling, after the activating, one or more of the motors in accordance with the roll angle and the pitch angle to stabilize an attitude of the unmanned aerial vehicle.

13. The method of claim 8, wherein the unmanned aerial vehicle further includes an altitude sensor for determining a current altitude of the unmanned aerial vehicle, the method further comprising:
determining a predetermined flight altitude of the unmanned aerial vehicle; and
controlling, after the activating, one or more of the motors to adjust the current altitude to the predetermined flight altitude, to hover the unmanned aerial vehicle.

14. The method of claim 8, wherein the unmanned aerial vehicle further includes a global positioning system (GPS) sensor for determining a current position of the unmanned aerial vehicle, the method further comprising:
determining, when the motion parameter is greater than the threshold value, a takeoff position recorded by the global positioning system (GPS) sensor; and
controlling, after the activating, one or more of the motors to move the unmanned aerial vehicle to the takeoff position in accordance with the current position.

15. An unmanned aerial vehicle, comprising:
one or more motors configured to drive one or more propellers of the unmanned aerial vehicle;
a motion sensor configured to determine a motion parameter of the unmanned aerial vehicle;
a memory storing instructions; and
a processor coupled to the one or more motors, the motion sensor, and the memory, and configured to execute the instructions to cause the unmanned aerial vehicle to:
determine whether a hand thrown mode is selected for the unmanned aerial vehicle and whether the one or more motors are turned off;
responsive to a determination that the hand thrown mode is selected, receive a motion parameter from the motion sensor; and
activate one or more of the motors when the motion parameter is greater than a threshold value.

16. The unmanned aerial vehicle of claim 15, wherein the motion parameter comprises an upward acceleration against gravity, determined by the motion sensor, of the unmanned aerial vehicle, and the threshold value comprises an acceleration threshold, and the processor is configured to execute the instructions to cause the unmanned aerial vehicle to activate the one or more motors by:
activating one or more of the motors when the upward acceleration is greater than the acceleration threshold.

17. The unmanned aerial vehicle of claim 15, wherein the motion parameter comprises a velocity, determined by the motion sensor, the threshold value comprises a velocity threshold, and the processor is configured to execute the instructions to cause the unmanned aerial vehicle to activate the one or more motors by:
activating one or more of the motors when the velocity is greater than the velocity threshold.

18. The unmanned aerial vehicle of claim 17, wherein the velocity corresponds to a vertical component of velocity, determined by the motion sensor, in a downward direction due to gravity.

19. The unmanned aerial vehicle of claim 15, wherein the motion sensor is further configured to determine a roll angle and a pitch angle of the unmanned aerial vehicle, and the processor is further configured to execute the instructions to cause the unmanned aerial vehicle to:
obtain the roll angle and the pitch angle determined by the motion sensor; and
control one or more of the motors in accordance with the roll angle and the pitch angle to stabilize an attitude of the unmanned aerial vehicle after activating the one or more motors.

20. The unmanned aerial vehicle of claim 15, further comprising:
an altitude sensor configured to determine a current altitude of the unmanned aerial vehicle;
wherein the memory is further configured to store a predetermined flight altitude of the unmanned aerial vehicle, and the processor is further configured to execute the instructions to cause the unmanned aerial vehicle to:
determine the predetermined flight altitude stored in the memory; and
control one or more of the motors to adjust the current altitude to the predetermined flight altitude, to hover the unmanned aerial vehicle after activating the one or more of the motors.

21. The unmanned aerial vehicle of claim 15, further comprising:
a global positioning system (GPS) sensor configured to record a takeoff position of the unmanned aerial vehicle and determine a current position of the unmanned aerial vehicle;
wherein the processor is further configured to execute the instructions to:
determine, when the motion parameter is greater than the threshold value, the takeoff position recorded by the global positioning system (GPS) sensor; and
control the one or more motors to move the unmanned aerial vehicle to the takeoff position in accordance with the current position after activating the one or more motors.
